(19) United States
(12) Patent Application Publication
(10) Pub. No.: US 2026/0359681 A1
(43) Pub. Date: Nov. 12, 2026

(54) METHOD FOR DECISION-MAKING PROCESSING BASED ON RELATIONSHIP GRAPH, AND DEVICE

(71) Applicant: CHINA UNIONPAY CO., LTD., Shanghai (CN)

(72) Inventors: Hejian GU, Shanghai (CN); Jintao ZHAO, Shanghai (CN); Jianbin ZHENG, Shanghai (CN); Pengfei GAO, Shanghai (CN)

(21) Appl. No.: 19/723,062

(22) Filed: Jun. 29, 2026

Related U.S. Application Data
(63) Continuation of application No. PCT/CN2024/141718, filed on Dec. 24, 2024.

(30) Foreign Application Priority Data
Dec. 28, 2023 (CN) 202311845743.4

(51) Int. Cl. G06N 5/04

(52) U.S. Cl. CPC G06N 5/04

(57) ABSTRACT

A method for decision-making processing based on a relationship graph and a device. The method includes: determining initial decision-making results respectively corresponding to a plurality of decision-making objects; determining association information among the plurality of decision-making objects, the association information including a similarity between any two decision-making objects in terms of decision-making factors; constructing a first relationship graph according to the association information among the plurality of decision-making objects, where each node in the first relationship graph corresponds to one decision-making object, and when there is a first connection edge between the two decision-making objects, an edge weight of the first connection edge is positively correlated with the association information; and by means of the first relationship graph, updating the initial decision-making results respectively corresponding to the plurality of decision-making objects, to obtain a target decision-making result of each decision-making object.

### CROSS-REFERENCE TO RELATED APPLICATIONS

This application is a continuation of International Application No. PCT/CN2024/141718, filed on Dec. 24, 2024, which claims priority to Chinese patent application No. 202311845743.4, filed to China National Intellectual Property Administration on Dec. 28, 2023, and entitled “METHOD FOR DECISION-MAKING PROCESSING BASED ON RELATIONSHIP GRAPH, AND DEVICE”, both of which are hereby incorporated by reference in their entireties.

### FIELD

The present application relates to the field of artificial intelligence, and in particular, to a method for decision-making processing based on a relationship graph, and a device.

### BACKGROUND

In the field of artificial intelligence, decision-making processing may be intelligently performed based on one or more factors to obtain a decision-making result. In this decision-making scenario, the factors required for decision-making are various factors that will affect the decision-making result and may be referred to as decision-making factors. For example, decision-making processing may be performed according to factors of a decision-making object (e.g., a merchant or a bank) on various dimensions to determine a state of this decision-making object.

### SUMMARY

Embodiments of the present application provide a method for decision-making processing based on a relationship graph, and the method includes:
determining initial decision-making results respectively corresponding to a plurality of decision-making objects;
determining association information among the plurality of decision-making objects, where the association information includes a similarity between any two of the decision-making objects in terms of a decision-making factor;
constructing a first relationship graph according to the association information among the plurality of decision-making objects, where each node in the first relationship graph corresponds to one of the decision-making objects, and when there is a first connection edge between two decision-making objects, an edge weight of the first connection edge is positively correlated with the association information; and
by means of the first relationship graph, updating the initial decision-making results respectively corresponding to the plurality of decision-making objects, to obtain a target decision-making result of each decision-making object.

Embodiments of the present application provide an apparatus for decision-making processing based on a relationship graph, and the apparatus includes:
an initial decision-making module, configured to determine initial decision-making results respectively corresponding to a plurality of decision-making objects;
an association determining module, configured to determine association information among the plurality of decision-making objects, where the association information includes a similarity between any two of the decision-making objects in terms of decision-making factors;
a first graph constructing module, configured to construct a first relationship graph according to the association information among the plurality of decision-making objects, where each node in the first relationship graph corresponds to one of the decision-making objects, and when there is a first connection edge between two decision-making objects, an edge weight of the first connection edge is positively correlated with the association information; and
a target decision-making module, configured to, by means of the first relationship graph, update the initial decision-making results respectively corresponding to the plurality of decision-making objects, to obtain a target decision-making result of each decision-making object.

Embodiments of the present application provide an electronic device, including a memory and at least one processor, where
the memory is configured to store computer-executable instructions therein; and
the at least one processor is configured to execute the computer-executable instructions stored in the memory, and the electronic device implements the method in the first aspect.

Embodiments of the present application provide a non-transitory computer-readable storage medium. The computer-readable storage medium has computer-executable instructions stored therein, the computer-executable instructions, when being executed by a processor, are configured to implement the method in the first aspect.

### BRIEF DESCRIPTION OF DRAWINGS

FIG. 1 is a schematic diagram of a decision-making processing process.

FIG. 2 is a flowchart of steps of a method for decision-making processing based on a relationship graph provided by an embodiment of the present application.

FIG. 3 is a schematic structural diagram of a second relationship graph provided by an embodiment of the present application.

FIG. 4 is a schematic structural diagram of a first relationship graph provided by an embodiment of the present application.

FIG. 5A and FIG. 5B are a flowchart of steps of another method for decision-making processing based on a relationship graph provided by an embodiment of the present application.

FIG. 6 is a structural block diagram of an apparatus for decision-making processing based on a relationship graph provided by an embodiment of the present application.

FIG. 7 is a structural block diagram of an electronic device provided by an embodiment of the present application.

### DESCRIPTION OF EMBODIMENTS

The exemplary embodiments will be described herein, and examples thereof are shown in accompanying drawings. When the following description involves the accompanying drawings, unless otherwise indicated, the same reference numbers in different accompanying drawings indicate the same or similar elements. The implementations described in the following exemplary embodiments are not all the implementations consistent with the present application. On the contrary, these implementations are simply examples of apparatuses and methods consistent with some aspects of the present application, as detailed in the appended claims.

User information (including but not limited to user device information, user personal information, etc.) and data (including but not limited to data used for analysis, stored data, displayed data, etc.) involved in the present application are information and data authorized by the user or fully authorized by all parties. In addition, the collection, use and processing of relevant data need to comply with relevant laws, regulations and standards, and provide corresponding operation entries for users to authorize or refuse.

A method for decision-making processing based on a relationship graph and a device in the present application may be used in the field of artificial intelligence, as well as in any field other than the field of artificial intelligence. The application fields of the method for decision-making processing based on the relationship graph and the device in the present application are not limited.

The decision-making processing in embodiments of the present application has a plurality of application scenarios, including but not limited to: a financial technology application scenario, an engineering application scenario, etc. For example, in the financial technology application scenario, capability evaluation, value evaluation, demand evaluation, supplier selection, strategic decision-making, manufacturing system decision-making and the like can be performed on a financial entity to obtain a decision-making result.

A decision-making object in the embodiments of the present application may be any object in any scenario in any field, including an entity object and a virtual object. For example, it may be a physical object such as a merchant, a bank, and a manufacturing system, etc., or a virtual object such as a deployment strategy and a manufacturing method, etc. In the case where decision-making objects are different or decision-making scenarios are different, decision-making results are different. For example, the decision-making result may be a capability evaluation result, an operation state and others of the entity object, or a result indicating whether to perform this deployment strategy or this manufacturing method.

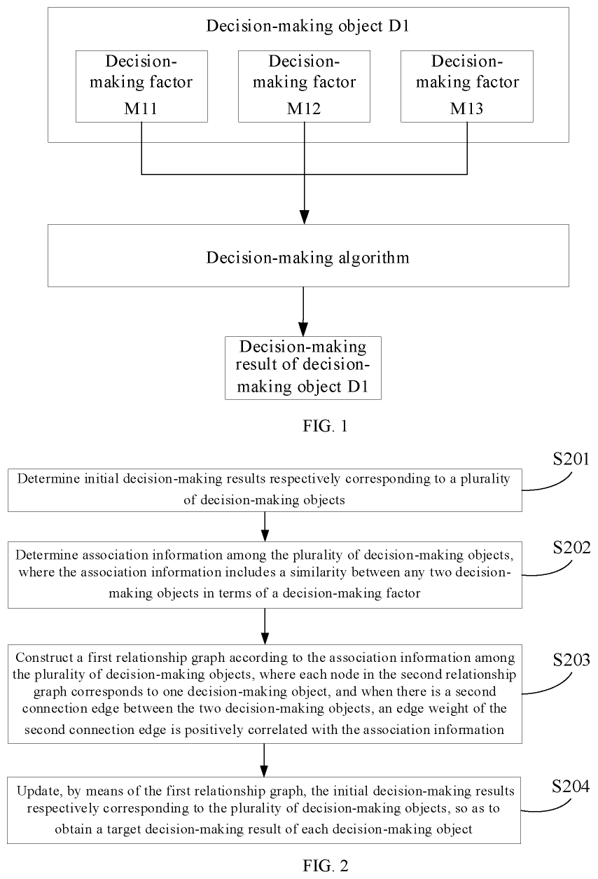

In one embodiment, a main process of decision-making processing may include: firstly, for a decision-making object, acquiring one or more decision-making factors of this decision-making object; and then, inputting all decision-making factors of this decision-making object into a decision-making algorithm to obtain a decision-making result. FIG. 1 is a schematic diagram of a decision-making processing process. Referring to FIG. 1, for the decision-making processing process of a decision-making object D1, decision-making factors M11, M12 and M13 of the decision-making object D1 may be input into a decision-making algorithm to obtain a decision-making result of the decision-making object D1. If the same decision-making processing needs to be applied to another decision-making object D2, decision-making factors M21, M22 and M23 of the decision-making object D2 need to be input into the decision-making algorithm to obtain a decision-making result of the decision-making object D2. For the same decision-making processing, the decision-making factors required are the same, so the decision-making factors M11 and M21 are of the same decision-making factor, but with different values. Similarly, M12 and M22 are of the same decision-making factor, but with different values; and M13 and M23 are of the same decision-making factor, but with different values.

However, when the above decision-making processing process makes a decision for a decision-making object, only the decision-making factors of one decision-making object are considered, resulting in low decision-making accuracy.

To solve the above problem, in the embodiments of the present application, an initial decision-making result of each decision-making object may be determined first to determine a target decision-making result of each decision-making object in combination with this initial decision-making result and association information among a plurality of decision-making objects. In this way, on the basis of the initial decision-making results, the association information among the decision-making objects can be fully utilized for decision-making processing, and the decision-making accuracy can be effectively improved.

For example, in a risk analysis scenario, it is determined that the risk of the decision-making object D1 is relatively high by means of the above decision-making processing scheme based on a plurality of decision-making factors, while the risk of the decision-making object D2 strongly associated with the decision-making object D1 is relatively low. In this scenario, the decision-making accuracy of the decision-making object D1 or the decision-making object D2 may be wrong. In the embodiments of the present application, decision-making processing is performed in combination with the association information of the decision-making objects and the initial decision-making results, and such strong association relationship between the decision-making object D1 and the decision-making object D2 may be identified. Therefore, the same target decision-making result of the decision-making object D1 and the decision-making object D2 can be obtained, which can ensure the consistency of the decision-making results of the two decision-making objects and help improve the decision-making accuracy.

The embodiments of the present application and how to solve the above problem by the embodiments of the present application are described below in conjunction with specific embodiments. The following specific embodiments may be combined with each other, and the same or similar concepts or processes may not be repeated in some embodiments. The embodiments of the present application will be described below in combination with the accompanying drawings.

FIG. 2 is a flowchart of steps of a method for decision-making processing based on a relationship graph provided by an embodiment of the present application. Referring to FIG. 2, a method for decision-making processing based on a relationship graph in the present application may include the following steps.

S201, determine initial decision-making results respectively corresponding to a plurality of decision-making objects.

Each decision-making object corresponds to one initial decision-making result, which may be a decision-making result obtained by means of any decision-making algorithm. For example, the initial decision-making result may be obtained by making a decision according to a plurality of decision-making factors, or by making a decision for the decision-making factors.

The above decision-making factors are related to specific decision-making scenarios. For example, for an operating entity, the decision-making factors may include, but are not limited to: marketing dependence, proportion of online operations, proportion of card-based operations, proportion of bank and merchant operations, proportion of non-financial operations, etc., to determine a state of the operating entity.

In some embodiments, the above initial decision-making results may be obtained through the following process: firstly, acquiring a decision-making weight corresponding to at least one decision-making factor, where a decision-making factor is used to perform decision-making processing on a plurality of decision-making objects, and a decision-making weight of a decision-making factor is used to indicate an influence degree of this decision-making factor on the decision-making processing; and then, performing decision-making processing according to a decision-making weight of a decision-making factor and a decision-making factor corresponding to a decision-making object to obtain an initial decision-making result of that decision-making object. In this way, the influence degree of the decision-making factor can be flexibly adjusted in combination with the decision-making weight, to achieve the purpose of flexibly adjusting the decision-making result and improving the decision-making flexibility.

The decision-making weight of the above decision-making factor is positively correlated with the influence degree of the decision-making factor on the decision-making processing. The larger a decision-making weight of a decision-making factor, the greater the influence of this decision-making factor on the decision-making processing. On the contrary, the smaller the decision-making weight of the decision-making factor, the less the influence of the decision-making factor on the decision-making processing.

It may be understood that the above initial decision-making result is positively correlated with the above decision-making weight and decision-making factor, respectively. In one embodiment, the above initial decision-making result may be calculated according to the following formula (1):

$$DR ( init ) = {\sum }_{i = 1}^{n} Wi \cdot Mi \qquad ( 1 )$$

in which, DR(init) is an initial decision-making result of a decision-making object; n is the number of decision-making factors required for the decision-making processing; Mi is an i^{th} decision-making factor of the decision-making object or a result of unitization processing of the i^{th} decision-making factor; and Wi is a decision-making weight corresponding to the i^{th} decision-making factor Mi of this decision-making object. i is a positive integer that is greater than or equal to 1 and less than or equal to n.

It may be understood that for the i^{th} decision-making factor, the unitization processing may be achieved by dividing the i^{th} decision-making factor by a sum of all decision-making factors of this decision-making object.

The decision-making weight here may be flexibly set manually according to application scenarios and requirements, or determined through S2011 to S2013.

S2011, construct a contrast matrix, where an element in an i^{th} row and a j^{th} column in the contrast matrix is used to represent a relative importance degree of an i^{th} decision-making factor compared to a j^{th} decision-making factor, and both i and j are integers greater than or equal to 1.

S2012, determine a priority matrix according to the contrast matrix, and the priority matrix includes priorities respectively corresponding to decision-making factors in the contrast matrix.

S2013, perform verification on the priority matrix to take, when the verification is passed, the priorities included in the priority matrix as decision-making weights of the decision-making factors.

The above contrast matrix may be an n×n matrix, i and j are integers greater than or equal to 1 and less than or equal to n, and n is the number of the decision-making factors.

The above-mentioned contrast matrix is determined by means of relative importance degrees among a plurality of decision-making factors. In order to construct the above-mentioned contrast matrix, a set of decision-making factors may be denoted as MS={M1, M2, . . . , Mn}, where M1, M2, . . . , Mn represent the first, second, up to the n^{th} decision-making factors, respectively. The relative importance degree of any i^{th} decision-making factor compared to any j^{th} decision-making factor may be obtained by means of scoring by an expert or automated determination.

The greater relative importance degree of any i^{th} decision-making factor compared to any j^{th} decision-making factor means that the i^{th} decision-making factor is more important than the j^{th} decision-making factor, and the i^{th} decision-making factor has a greater influence on the decision-making result than the j^{th} decision-making factor. On the contrary, the less relative importance degree of any i^{th} decision-making factor compared to any j^{th} decision-making factor means that the i^{th} decision-making factor is less important than the j^{th} decision-making factor, and the i^{th} decision-making factor has a less influence on the decision-making result than the j^{th} decision-making factor.

For example, when the expert experientially determines that the i^{th} decision-making factor and the j^{th} decision-making factor are equally important, the relative importance degree of the i^{th} decision-making factor compared to the j^{th} decision-making factor may be set to 1. When the expert experientially determines that the i^{th} decision-making factor is more important than the j^{th} decision-making factor, the relative importance degree of the i^{th} decision-making factor compared to the j^{th} decision-making factor may be set to be greater than 1. When the expert experientially determines that the j^{th} decision-making factor is more important than the i^{th} decision-making factor, the relative importance degree of the i^{th} decision-making factor compared to the j^{th} decision-making factor may be set to be less than 1.

A contrast matrix A, which is constructed according to the relative importance degrees among the plurality of decision-making factors, may be expressed as follows:

$$A = [ \begin{matrix}1 & A 12 & … & A 1 n \\ A 21 & … & … & A 2 n \\ … & … & … & … \\ An 1 & An 2 & … & 1\end{matrix} ] \qquad ( 2 )$$

in which, Aii=1 in the above-mentioned contrast matrix represents that the relative importance degree of the i^{th} decision-making factor compared to the i^{th} decision-making factor is 1. Aij=1/Aji represents the relative importance degree of the i^{th} decision-making factor compared to the j^{th} decision-making factor, which is reciprocal to the relative importance degree of the j^{th} decision-making factor compared to the i^{th} decision-making factor.

After the above contrast matrix A is obtained, a priority matrix P may be determined according to the contrast matrix A, where the priority matrix P includes priorities respectively corresponding to the decision-making factors in the contrast matrix A. A priority corresponding to each decision-making factor may be determined in two ways.

In the first priority determination way of the above-mentioned decision-making factors, according to a relative importance degree in each row in the contrast matrix, a priority of a decision-making factor corresponding to this row may be determined. For example, for the i^{th} decision-making factor, the relative importance degrees Ai1 to Ain in the i^{th} row in the contrast matrix A may be added or multiplied or averaged to obtain the priority of the i^{th} decision-making factor.

In the second priority determination way of the above decision-making factors, firstly, each column in the contrast matrix is subjected to unitization processing to obtain a unit contrast matrix; and then, an average value of each row in the unit contrast matrix is used as a priority of each decision-making factor in the priority matrix.

The unitization processing may be understood as normalized processing, which is used to process the relative importance degree in each column in the contrast matrix A to a numerical value that is greater than or equal to 0 and less than or equal to 1. A specific algorithm may be as follows:

$${A}^{′} ij = \frac{Aij}{{\sum }_{i = 1}^{n} Aij} \qquad ( 3 )$$

in which, A′ij is an element in an i^{th} row and a j^{th} column in a unit contrast matrix A′, and the unit contrast matrix A′ and the contrast matrix A are both n×n matrices.

Based on the above-mentioned unit contrast matrix A′, the priority of each decision-making factor may be obtained. Specifically, for the i^{th} decision-making factor, its priority may be calculated by means of the following formula:

$$Pi = \frac{{\sum }_{i = 1}^{n} {A}^{′} ij}{n} \qquad ( 4 )$$

in which, Pi is the priority of the i^{th} decision-making factor Mi. The higher priority means that the i^{th} decision-making factor Mi has a greater influence on the decision-making processing.

It can be seen that the above first priority determination way of the decision-making factors may lead to a large value of the determined priority, which is not conducive to subsequent operations during the decision-making processing. However, the above second priority determination way of the decision-making factors is to perform unitization of a column first, and then to determine a priority by means of the average value, to ensure that a numerical value of the priority is within a controllable range as much as possible, thereby facilitating reducing the complexity of subsequent operations.

After the above priority matrix is obtained, verification may be performed on the priority matrix to take, if the verification is passed, the priorities in the priority matrix as decision-making weights. If the verification for the priority matrix fails, a relative importance degree between the decision-making factors needs to be re-determined to reconstruct a contrast matrix, and a priority matrix is determined through S2011 to S2013 until the constructed priority matrix is validated successfully.

In some embodiments, firstly, a maximum feature value of the contrast matrix may be determined in combination with the above contrast matrix and priority matrix; then, an inspection index is determined according to the maximum feature value and the number of decision-making factors in the contrast matrix; and finally, whether the inspection index meets a preset condition is determined. If the inspection index meets the preset condition, it is determined that the verification for the priority matrix is passed; otherwise, it is determined that the verification for the priority matrix fails.

In one embodiment, the maximum feature value may be calculated by means of the following formula:

$$λ max = {\sum }_{i = 1}^{n} \frac{[ AP ] i}{n \cdot Pi} \qquad ( 5 )$$

in which, AP is a product of the n×n contrast matrix A and the n×1 priority matrix P; AP is an n×1 matrix; [AP]i is an i^{th} element in the matrix AP; and Pi is an i^{th} element in the priority matrix P. The larger maximum feature value means a large possibility of inconsistency in the above-mentioned contrast matrix A. That is to say, the setting of the contrast matrix A is unreasonable and there is a conflict in the relative importance degrees.

For instance, A12 is greater than 1 and A21 is less than 1, and at this time, it indicates that the first decision-making factor has a greater influence on the decision-making processing compared to the second decision-making factor. Meanwhile, A13 is less than 1 and A31 is greater than 1, and at this time, it indicates that the third decision-making factor has a greater influence on the decision-making processing compared to the first decision-making factor. Therefore, it may be inferred that the third decision-making factor has a greater influence on the decision-making processing compared to the second decision-making factor. However, A23 is greater than 1 and A32 is less than 1, and at this time, it indicates that the second decision-making factor has a greater influence on the decision-making processing compared to the third decision-making factor. In this way, a conflict arises. Under such circumstances, the corresponding maximum feature value takes a larger value.

After the above maximum feature value is obtained, the inspection index may be determined according to the maximum feature value and the number of decision-making factors. A specific formula is as follows:

$$CR = \frac{CI}{RI} = \frac{λmax}{( n - 1 ) \cdot RI} \qquad ( 6 )$$

in which, CR is the inspection index, which may be understood as a consistency ratio. CI is a consistency index, and RI is a random index, both of which may be obtained by looking up a table according to a dimension n of the contrast matrix.

After the above inspection index CR is obtained, if the inspection index is less than or equal to a preset threshold, it is determined that the verification for the priority matrix is passed; and if the inspection index is greater than the preset threshold, it is determined that the verification for the priority matrix fails. The preset threshold may be set based on experience, and for example, may be 0.1.

S202, determine association information among the plurality of decision-making objects, where the association information includes a similarity between any two decision-making objects in terms of a decision-making factor.

It may be understood that the association information is used to indicate an association relationship between any two decision-making objects. In addition to the similarity between any two decision-making objects in terms of the decision-making factor, the association information may also include a first association degree between any two decision-making objects, and the first association degree is used to indicate a dependence degree between the two decision-making objects.

The above similarity may be determined by means of the following steps: firstly, constructing all decision-making factors of each decision-making object into one vector as a decision-making factor vector of the decision-making object; and then, taking a similarity between decision-making factor vectors of two decision-making objects as the above similarity between the two decision-making objects in terms of the decision-making factors.

The similarity between the vectors may be calculated by means of a plurality of similarity algorithms, such as a cosine similarity, and a normal distance similarity. Taking the cosine similarity as an example, the above similarity between the decision-making objects in terms of the decision-making factors may be calculated by means of the following formula:

$$α bk = cossimilarity ( Vb , Vk ) = \frac{{\sum }_{i = 1}^{n} Vbi \cdot Vki}{\sqrt{{\sum }_{i = 1}^{n} {Vbi}^{2}} \cdot \sqrt{{\sum }_{i = 1}^{n} {Vki}^{2}}} \qquad ( 7 )$$

in which, αbk is a similarity between a b^{th} decision-making object and a k^{th} decision-making object in terms of the decision-making factors, and cossimilarity(Vb, Vk) is used to calculate a similarity between Vb and Vk. Vb and Vk are decision-making factor vectors respectively corresponding to both the b^{th} decision-making object and the k^{th} decision-making object. Vbi and Vki are i^{th} dimension values in the decision-making factor vectors respectively corresponding to the b^{th} decision-making object and the k^{th} decision-making object.

In addition, the above dependence degree between the two decision-making objects may be identified according to an interaction behavior between the decision-making objects, or by means of dependence degrees between the decision-making objects and a third-party object, and the dependence degrees between the decision-making objects and the third-party object may be determined through the interaction behavior.

In some embodiments, the dependence degree between the decision-making objects may be identified by means of the dependence degrees between the decision-making objects and the third-party object, which may be achieved through the following process: firstly, constructing a second relationship graph by means of the plurality of decision-making objects and at least one third-party object, where each node in the second relationship graph corresponds to one decision-making object or one third-party object, and when there is a second connection edge between one decision-making object and one third-party object, an edge weight of the second connection edge is used to indicate a second association degree between the decision-making object and the third-party object; and then, for two decision-making objects in the second relationship graph that are connected to at least one identical third-party object, determining a first association degree between the two decision-making objects according to a second association degree between each of the two decision-making objects and the identical third-party object.

The above second relationship graph includes all decision-making objects and all third-party objects interacting with these decision-making objects. Each node in the second relationship graph corresponds to one decision-making object or one third-party object. When one decision-making object and one third-party object have an interaction behavior, this decision-making object and this third-party object are connected by means of an edge, which is called a second connection edge. For example, the decision-making object may be a bank branch, and the third-party object may be a merchant. The second connection edge may be used to indicate that there is a transaction between the bank branch and the merchant. A weight of the second connection edge may be a transaction amount or a transaction frequency, etc. Therefore, the second relationship graph may be constructed by means of a plurality of bank branches and a plurality of merchants as well as transaction behaviors therebetween to perform decision-making processing for the bank branches and determine their operation states. Of course, decision-making processing may also be performed for the merchants. At this time, the merchants are the decision-making objects and the bank branches are the third-party objects.

The above second association degree corresponding to the above second connection edge in the embodiments of the present application is used to indicate an association degree between the decision-making object and the third-party object which are connected by the second connection edge. The second association degree may correspond to different measurement indicators in different scenarios. For example, in a transaction scenario, the second association degree may be a transaction amount, a transaction frequency, etc.

Based on the above second relationship graph, two decision-making objects connected to at least one identical third-party object may be found and called a group of associated decision-making objects. There are a plurality of groups of such associated decision-making objects in the second relationship graph. The first association degree between the two decision-making objects is positively correlated with the corresponding second association degrees, and in one embodiment, may be calculated by means of the following formula:

$$Ybk = {\sum }_{r = 1}^{R} Zbr \cdot Zkr \qquad ( 8 )$$

in which, Ybk represents a first association degree between the b^{th} decision-making object and the k^{th} decision-making object. R represents the number of third-party objects to which both the b^{th} decision-making object and the k^{th} decision-making object are connected, and r is an integer that is greater than or equal to 1 and less than or equal to R. Zbr represents a second association degree between the b^{th} decision-making object and the r^{th} third-party object, while Zkr represents a second association degree between the k^{th} decision-making object and the r^{th} third-party object.

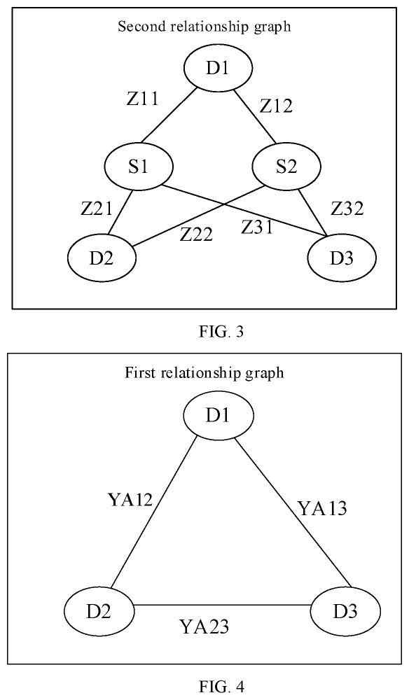

FIG. 3 is a schematic structural diagram of a second relationship graph provided by an embodiment of the present application. Referring to FIG. 3, the second relationship graph includes three decision-making objects D1, D2 and D3, as well as two third-party objects S1 and S2. It may be understood that FIG. 3 exemplarily shows a relatively small number of decision-making objects and third-party objects for the sake of simplicity. However, in actual applications, the number of decision-making objects and the number of third-party objects in the second relationship graph are not limited to the numbers shown in FIG. 3.

Referring to FIG. 3, a second association degree between the first decision-making object D1 and the first third-party object S1 is Z11; a second association degree between the first decision-making object D1 and the second third-party object S2 is Z12; a second association degree between the second decision-making object D2 and the first third-party object S1 is Z21; a second association degree between the second decision-making object D2 and the second third-party object S2 is Z22; a second association degree between the third decision-making object D3 and the first third-party object S1 is Z31; and a second association degree between the third decision-making object D3 and the second third-party object S2 is Z32.

From the second relationship graph shown in FIG. 3, it can be seen that the first decision-making object D1 and the second decision-making object D2 are not only jointly connected to the third-party object S1, but also jointly connected to the third-party object S2. Therefore, according to the above formula (8), a first association degree between the first decision-making object D1 and the second decision-making object D2 may be calculated as Y12=Z11×Z21+Z12×Z22. Similarly, a first association degree between the first decision-making object D1 and the third decision-making object D3 may be obtained as Y13=Z11×Z31+Z12×Z32, and a first association degree between the second decision-making object D2 and the third decision-making object D3 may be obtained as Y23=Z21×Z31+Z22×Z32.

It may be understood that the construction process of the above second relationship graph may include the following steps: firstly, determining all decision-making objects and all third-party objects that have interaction behaviors with these decision-making objects, then determining whether there is an interaction behavior between any decision-making object and a third-party object, and determining a corresponding second association degree according to the interaction behavior between the decision-making object and the third-party object in the presence of the interaction behavior; then, taking each decision-making object and each third-party object as a node in the second relationship graph, respectively; and finally, connecting the decision-making object and the third-party object, which have the interaction behavior, through a second connection edge, and taking a second association degree between this decision-making object and the third-party object as an edge weight of this second connection edge.

After the second relationship graph is constructed, all the associated decision-making objects may be found from the second relationship graph to calculate a first association degree between the associated decision-making objects by means of the formula (8).

It can be seen that in the embodiments of the present application, a relationship between the decision-making objects and the third-party objects may be represented visually and accurately by means of the second relationship graph, and the first association degree may be determined accurately based on the second association degree.

After the above association information is obtained, a target decision-making result of each decision-making object may be determined according to the association information among the plurality of decision-making objects and the initial decision-making results respectively corresponding to the plurality of decision-making objects.

The target decision-making results may be understood as being obtained by updating the initial decision-making results by means of the association information. When the target decision-making results and the initial decision-making results are represented in the form of numerical values, the target decision-making results are positively correlated not only with the initial decision-making results, but also with the association degree represented by the association information.

In some embodiments, the above association information may be used to indicate whether there is an association between the decision-making objects. By means of an initial decision-making result of a decision-making object (which may be denoted as a first decision-making object), an initial decision-making result of a decision-making object (which may be denoted as a second decision-making object) associated with this decision-making object may be updated as a target decision-making result of the second decision-making object. For example, if the initial decision-making result of the first decision-making object is relatively large, the initial decision-making result of the second decision-making object can be increased.

In other implementations, the above association information among the decision-making objects may further include an association degree between any two decision-making objects, that is, the above first association degree, to accurately adjust an initial decision-making result based on the first association degree. The target decision-making result is positively correlated with the first association degree and the initial decision-making result, respectively. For example, the target decision-making result of the second decision-making object may be a product of a first association degree between the first decision-making object and the second decision-making object and an initial decision-making result of the second decision-making object.

In some embodiments, the above process of determining the target decision-making result is a process of updating the initial decision-making result in combination with the first relationship graph, and, in one embodiment, includes S203 and S204.

S203, construct a first relationship graph according to the association information among the plurality of decision-making objects, where each node in the first relationship graph corresponds to one decision-making object, and when there is a first connection edge between the two decision-making objects, an edge weight of the first connection edge is positively correlated with the association information.

The above first relationship graph may be obtained by deleting third-party objects from the second relationship graph, or may be constructed directly according to the decision-making objects. The above edge weight of the first connection edge may also be understood as a third association degree between the two decision-making objects, and the third association degree is positively correlated with the above association information.

When the third-party objects are deleted from the second relationship graph to obtain the first relationship graph, each time one third-party object is deleted, the decision-making objects, to which the third-party object are connected, are connected as a first connection edge in the first relationship graph.

When the first relationship graph is directly constructed by means of the plurality of decision-making objects, each decision-making object may be taken as a node, and a first connection edge between these decision-making objects may be constructed according to the association information.

It can be seen that the above first relationship graph is used to represent an association relationship among all the decision-making objects and the third association degree. The first relationship graph includes all decision-making objects, and each decision-making object acts as one node. The third association degree between two decision-making objects in the first relationship graph may be positively correlated with a first association degree between the two decision-making objects, and with a similarity between the two decision-making objects in terms of the decision-making factors. For example, the third association degree between two decision-making objects in the first relationship graph may be a result obtained by multiplying the first association degree between the two decision-making objects by the similarity between the two decision-making objects in terms of the decision-making factors.

FIG. 4 is a schematic structural diagram of a first relationship graph provided by an embodiment of the present application. The first relationship graph shown in FIG. 4 is obtained by deleting third-party objects from the second relationship graph shown in FIG. 3. Referring to FIG. 4, the first relationship graph includes three decision-making objects D1, D2 and D3, where a third association degree YA12 between the decision-making object D1 and the decision-making object D2 is obtained by multiplying a first association degree Y12 between the decision-making object D1 and the decision-making object D2 by a similarity α12 between the decision-making object D1 and the decision-making object D2 in terms of the decision-making factors; a third association degree YA13 between the decision-making object D1 and the decision-making object D3 is obtained by multiplying a first association degree Y13 between the decision-making object D1 and the decision-making object D3 by a similarity α13 between the decision-making object D1 and the decision-making object D3 in terms of the decision-making factors; and a third association degree YA23 between the decision-making object D2 and the decision-making object D3 is obtained by multiplying a first association degree Y23 between the decision-making object D2 and the decision-making object D3 by a similarity α23 between the decision-making object D2 and the decision-making object D3 in terms of the decision-making factors.

S204, update, by means of the first relationship graph, the initial decision-making results respectively corresponding to the plurality of decision-making objects, to obtain a target decision-making result of each decision-making object.

In the embodiments of the present application, by means of the first relationship graph, the initial decision-making results respectively corresponding to the plurality of decision-making objects are updated, to obtain the target decision-making result of each decision-making object. That is, the decision-making processing is performed based on the first relationship graph by means of an influence propagation algorithm.

In the embodiments of the present application, the association relationship between the decision-making objects may be accurately determined by means of the first relationship graph, to accurately update the initial decision-making objects respectively corresponding to the decision-making objects in the first relationship graph, and obtain the target decision-making result of each decision-making object.

In addition, a weight of the first connection edge in the above first relationship graph in the embodiments of the present application combines the similarity and the first association degree to describe the association relationship between the decision-making objects from these two aspects, which can improve the association accuracy between the decision-making objects as much as possible. Compared with the traditional influence propagation algorithm in which the mutual influence between adjacent decision-making objects is relatively great, the influence in the present application takes not only an adjacency relationship between the decision-making objects, but also the similarity between the decision-making objects in terms of the decision-making factors into account. This facilitates further improving the decision-making accuracy.

In some embodiments, S204 may include the following steps: firstly, for each decision-making object, updating a preset damping coefficient to obtain a dynamic damping coefficient according to an average similarity between the decision-making object and each adjacent decision-making object of this decision-making object in terms of the decision-making factor(s); and then, by means of the dynamic damping coefficient, updating the initial decision-making results respectively corresponding to the plurality of decision-making objects in the first relationship graph, to obtain the target decision-making result of each decision-making object, where the dynamic damping coefficient is used to control a decision-making propagation difficulty between the decision-making object and the adjacent decision-making object(s).

An adjacent decision-making object is a decision-making object which is directly connected to this decision-making object. For example, for the decision-making object D1 shown in FIG. 4, its adjacent decision-making objects include decision-making objects D2 and D3.

The average similarity here is an average value of respective similarities between this decision-making object and all adjacent decision-making objects in terms of the decision-making factors. The similarities between this decision-making object and the adjacent decision-making objects in terms of the decision-making factors may be calculated by means of the above formula (7).

The dynamic damping coefficient is positively correlated with the above average similarity and with the preset damping coefficient. That is, as the preset damping coefficient increases and/or the average similarity increases, the dynamic damping coefficient increases. The preset damping coefficient is a preset fixed value. Compared with the solution in which the propagation difficulty between nodes is controlled by means of the preset damping coefficient, in the present application, the decision-making propagation difficulty between the decision-making objects can be controlled by means of the dynamic damping coefficient.

In the embodiments of the present application, the propagation difficulty of the decision-making results among different decision-making objects can be flexibly controlled by means of the above dynamic damping coefficient. The smaller the average similarity between the decision-making object and each adjacent decision-making object in terms of the decision-making factors, the lower the similarity level between the decision-making object and the adjacent decision-making object. At this time, the smaller the dynamic damping coefficient is, the more difficult it is to propagate the decision-making result between the decision-making object and the adjacent decision-making object, that is, the smaller an update amplitude of the updated decision-making result. On the contrary, the greater the average similarity between the decision-making object and each adjacent decision-making object in terms of the decision-making factors, the higher the similarity level between the decision-making object and the adjacent decision-making object. At this time, the larger the dynamic damping coefficient is, the less difficult it is to propagate the decision-making result between the decision-making object and the adjacent decision-making object, that is, the larger an updated amplitude of the updated decision-making result.

In some embodiments, the process of updating the initial decision-making results to obtain the target decision-making results based on the above first relationship graph may, in one embodiment, include a plurality of rounds of iterations. In each round of iteration, for each decision-making object, an updated decision-making result of the decision-making object in the iteration is determined according to the dynamic damping coefficient and target information of the decision-making object in the first relationship graph, where the target information includes an edge weight of the first connection edge between the decision-making object and the adjacent decision-making object of this decision-making object in the first relationship graph, and an updated decision-making result of the adjacent decision-making object in a previous round of iteration. After each round of iteration, if the updated decision-making results respectively corresponding to the plurality of decision-making objects meet a preset convergence condition, the updated decision-making results respectively corresponding to the plurality of decision-making objects are taken as corresponding target decision-making results.

It may be understood that, before the first round of iteration is carried out, the initial decision-making result of each decision-making object is taken as the updated decision-making result of this decision-making object, so as to start the first round of iteration. Therefore, in the first round of iteration, the updated decision-making result of the adjacent decision-making object in the previous round of iteration is the initial decision-making result of this adjacent decision-making object. In the second and subsequent C^{th} rounds of iterations, the updated decision-making result of the adjacent decision-making object in the previous round of iteration is an updated decision-making result obtained for this adjacent decision-making object after the (C−1)^{th} round of iteration.

The updated decision-making result of the decision-making object in the iteration is positively correlated with two items in the target information, and may be flexibly adjusted on the basis of this positive association. That is, with the increase of the edge weight of the first connection edge between the decision-making object and the adjacent decision-making object of this decision-making object in the first relationship graph, and/or with the increase of the updated decision-making result of the adjacent decision-making object in the previous round of iteration, the updated decision-making result of the decision-making object in the iteration will also increase accordingly.

Therefore, in each round of iteration, for each decision-making object, the updated decision-making result of this decision-making object in the iteration may be determined according to target information of this decision-making object in the first relationship graph, to implement one update of the decision-making result of the object. After each round of iteration, whether the updated decision-making results respectively corresponding to the plurality of decision-making objects meet a preset convergence condition may be determined. If the preset convergence condition is not met, it means that the iteration has not reached a stable state, so it is necessary to enter the next round of iteration. If the preset convergence condition is met, it means that the iteration has reached a stable state and it may be determined that the iteration converges. At this time, the updated decision-making result of each decision-making object obtained in this round of iteration may be used as the target decision-making result corresponding to the decision-making object.

The above preset convergence condition may be that a change degree of the updated decision-making results of all decision-making objects is less than or equal to a preset change threshold, e.g., less than or equal to 0.0001. This change degree may be obtained by the following process: firstly, determining change degrees of the updated decision-making results obtained for each decision-making object in a plurality of consecutive rounds of iterations; and then, averaging the change degrees of all the decision-making objects as the change degree of the updated decision-making results of all the decision-making objects.

It can be seen from the above process that in the embodiments of the present application, the updated decision-making results are continuously iterated, to take, when the decision-making results tend to be stable, the updated decision-making results that tend to be stable as the target decision-making results. Therefore, the accuracy of the target decision-making results can be ensured as much as possible.

In some embodiments, the determining the updated decision-making result of the decision-making object in the above iteration according to the dynamic damping coefficient and the target information of the decision-making object in the first relationship graph may, in one embodiment, include the following steps: firstly, determining an intermediate decision-making result corresponding to the decision-making object in the above iteration according to the edge weight of the first connection edge between this decision-making object and each adjacent decision-making object and the updated decision-making result corresponding to the adjacent decision-making object in the previous round of iteration; and then, determining the updated decision-making result of this decision-making object in the above iteration according to the dynamic damping coefficient and the intermediate decision-making result.

The above intermediate decision-making result may be positively correlated with the above edge weight of the first connection edge and the above updated decision-making result.

The updated decision-making result corresponding to the decision-making object in the above iteration is negatively correlated with the above dynamic damping coefficient, and positively correlated with the above intermediate decision-making result.

In some embodiments, the above dynamic damping coefficient may adjust not only the propagation difficulty, but also the above intermediate decision-making result. Therefore, the determining the updated decision-making result corresponding to the decision-making object in the iteration according to the dynamic damping coefficient and the intermediate decision-making result may, in one embodiment, include: updating the intermediate decision-making result by means of the dynamic damping coefficient to determine the updated decision-making result corresponding to the decision-making object in the iteration according to an updated intermediate decision-making result and the dynamic damping coefficient.

The updated intermediate decision-making result is positively correlated with the dynamic damping coefficient and positively correlated with the intermediate decision-making result before the updating.

The following example gives a calculation formula for an updated decision-making result corresponding to a decision-making object in the iteration:

$${DRb}^{′} ( ref ) = h - DP \cdot α b + DP \cdot α b \cdot {\sum }_{k = 1}^{K} α bk \cdot Ybk \cdot DRk ( ref ) \qquad ( 9 )$$

in which, DRb′(ref) is an updated decision-making result obtained for the b^{th} decision-making object Db in the current iteration, and h is a constant that may take a value of 1. DP is the preset damping coefficient. αb is an average similarity between the b^{th} decision-making object Db and all adjacent decision-making objects thereof in terms of the decision-making factors. K is the number of adjacent decision-making objects of the b^{th} decision-making object Db. αbk is a similarity between the b^{th} decision-making object Db and its k^{th} adjacent decision-making object Dk in terms of the decision-making factors. Ybk is a first association degree between the b^{th} decision-making object Db and its k^{th} adjacent decision-making object Dk. DRk(ref) is an updated decision-making result obtained for the k^{th} adjacent decision-making object Dk in the previous round of iteration.

It should be noted that in the above-mentioned formula (9), DP·αb may be understood as the dynamic damping coefficient,

$${\sum }_{k = 1}^{K} α bk \cdot Ybk \cdot DRk ( ref )$$

may be understood as an intermediate decision-making result corresponding to the b^{th} decision-making object before the updating, and

$$DP \cdot α b \cdot {\sum }_{k = 1}^{K} α bk \cdot Ybk \cdot DRk ( ref )$$

may be understood as an intermediate decision-making result corresponding to the b^{th} decision-making object after the updating. αbk·Ybk may be understood as a third association degree between the b^{th} decision-making object Db and its k^{th} adjacent decision-making object Dk.

In summary, in the embodiments of the present application, the association relationship between the decision-making objects and the third association degree may be expressed by means of the first relationship graph, to perform decision-making processing on the plurality of decision-making objects based on the first association graph. The association information among the decision-making objects can be fully used to improve the accuracy of the decision-making processing. When the initial decision-making result of the decision-making object is calculated based on the decision-making factors and the weights thereof, the decision-making processing is implemented in combination with the importance of the decision-making factors and the association information between the decision-making factors, which can further improve the decision-making accuracy. In addition, the association information may include two aspects: the similarity between the decision-making objects in terms of the decision-making factors and the first association degree between the decision-making objects, to describe the association relationship between the decision-making objects from these two aspects, which can improve the comprehensiveness of the association relationship and help to further improve the decision-making accuracy.

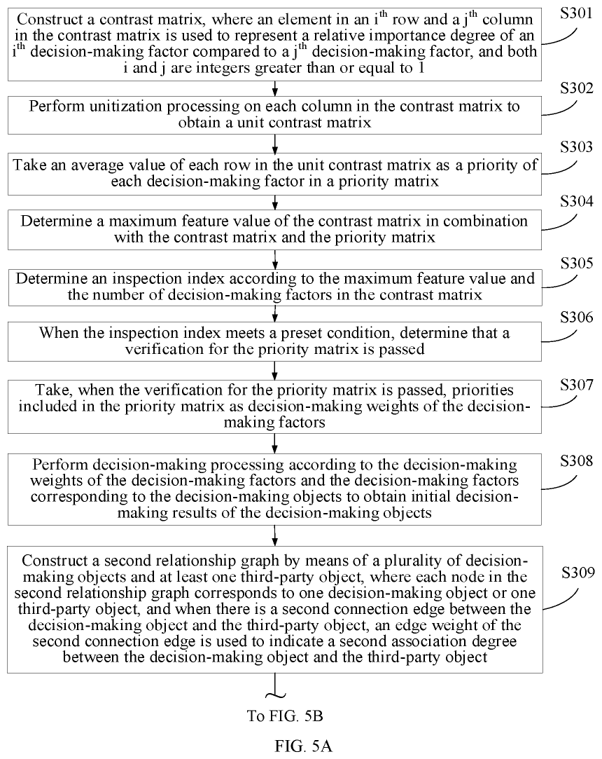

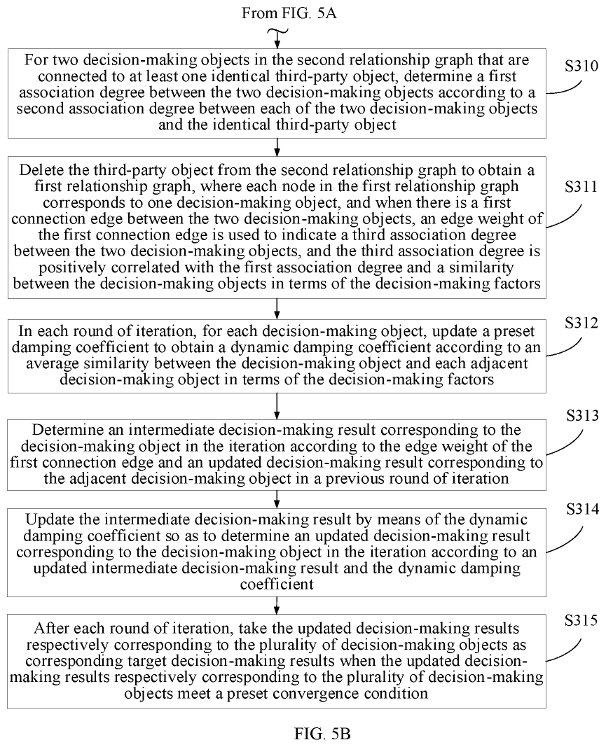

FIG. 5A and FIG. 5B are a flowchart of steps of another method for decision-making processing based on a relationship graph provided by an embodiment of the present application. Referring to FIG. 5A and FIG. 5B, the detailed flow of the above decision-making processing process includes the following steps.

S301, construct a contrast matrix, where an element in an i^{th} row and a j^{th} column in the contrast matrix is used to represent a relative importance degree of an i^{th} decision-making factor compared to a j^{th} decision-making factor, and both i and j are integers greater than or equal to 1.

S302, perform unitization processing on each column in the contrast matrix to obtain a unit contrast matrix.

S303, take an average value of each row in the unit contrast matrix as a priority of each decision-making factor in a priority matrix.

S304, determine a maximum feature value of the contrast matrix in combination with the contrast matrix and the priority matrix.

S305, determine an inspection index according to the maximum feature value and the number of decision-making factors in the contrast matrix.

S306, when the inspection index meets a preset condition, determine that a verification for the priority matrix is passed.

S307, take, when the verification for the priority matrix is passed, priorities included in the priority matrix as decision-making weights of the decision-making factors.

S308, perform decision-making processing according to the decision-making weights of the decision-making factors and the decision-making factors corresponding to the decision-making objects to obtain initial decision-making results of the decision-making objects.

S309, construct a second relationship graph by means of a plurality of decision-making objects and at least one third-party object, where each node in the second relationship graph corresponds to one decision-making object or one third-party object, and when there is a second connection edge between the decision-making object and the third-party object, an edge weight of the second connection edge is used to indicate a second association degree between the decision-making object and the third-party object.

S310, for two decision-making objects in the second relationship graph that are connected to at least one identical third-party object, determine a first association degree between the two decision-making objects according to a second association degree between each of the two decision-making objects and the identical third-party object.

S311, delete the third-party object from the second relationship graph to obtain a first relationship graph, where each node in the first relationship graph corresponds to one decision-making object, and when there is a first connection edge between the two decision-making objects, an edge weight of the first connection edge is used to indicate a third association degree between the two decision-making objects, and the third association degree is positively correlated with the first association degree and a similarity between the decision-making objects in terms of the decision-making factors.

S312, in each round of iteration, for each decision-making object, update a preset damping coefficient to obtain a dynamic damping coefficient according to an average similarity between the decision-making object and each adjacent decision-making object in terms of the decision-making factors.

S313, determine an intermediate decision-making result corresponding to the decision-making object in the iteration according to the edge weight of the first connection edge and an updated decision-making result corresponding to the adjacent decision-making object in a previous round of iteration.

S314, update the intermediate decision-making result by means of the dynamic damping coefficient to determine an updated decision-making result corresponding to the decision-making object in the iteration according to an updated intermediate decision-making result and the dynamic damping coefficient.

S315, after each round of iteration, take the updated decision-making results respectively corresponding to the plurality of decision-making objects as corresponding target decision-making results when the updated decision-making results respectively corresponding to the plurality of decision-making objects meet a preset convergence condition.

The sequence of the above S301 to S315 can be flexibly adjusted on a mutually independent basis, and will not be limited in the present application. Steps S301 to S315 in the present application may be described by reference to corresponding contents in the above S201 to S203, and will not be repeated here.

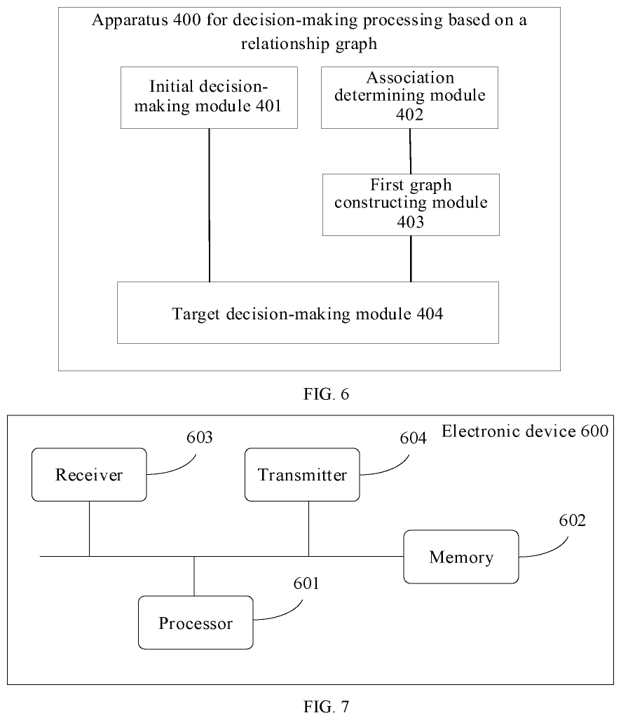

FIG. 6 is a structural block diagram of an apparatus for decision-making processing based on a relationship graph provided by an embodiment of the present application. Referring to FIG. 6, the above apparatus 400 for decision-making processing based on a relationship graph includes:
an initial decision-making module 401, configured to determine initial decision-making results respectively corresponding to a plurality of decision-making objects;
an association determining module 402, configured to determine association information among the plurality of decision-making objects, where the association information includes a similarity between any two of the decision-making objects in terms of a decision-making factor;
a first graph constructing module 403, configured to construct a first relationship graph according to the association information among the plurality of decision-making objects, where each node in the first relationship graph corresponds to one decision-making object, and when there is a first connection edge between two decision-making objects, an edge weight of the first connection edge is positively correlated with the association information; and
a target decision-making module 404, configured to, by means of the first relationship graph, update the initial decision-making results respectively corresponding to the plurality of decision-making objects, to obtain a target decision-making result of each decision-making object.

In one embodiment, the target decision-making module 404 is further configured to:
for each decision-making object, update a preset damping coefficient to obtain a dynamic damping coefficient according to an average similarity between the decision-making object and each adjacent decision-making object of this decision-making object in terms of the decision-making factor; and by means of the dynamic damping coefficient, update the initial decision-making results respectively corresponding to the plurality of decision-making objects in the first relationship graph, to obtain the target decision-making result of each decision-making object, where the dynamic damping coefficient is used to control a decision-making propagation difficulty between the decision-making object and the adjacent decision-making objects.

In one embodiment, the target decision-making module 404 is further configured to:
in each round of iteration of the updating, for each decision-making object, determine an updated decision-making result of the decision-making object in the iteration according to the dynamic damping coefficient and target information of the decision-making object in the first relationship graph, where the target information includes an edge weight of the first connection edge between the decision-making object and the adjacent decision-making object of this decision-making object in the first relationship graph and an updated decision-making result of the adjacent decision-making object in a previous round of iteration, and the updated decision-making result is initially the initial decision-making result; and after each round of iteration, take, if the updated decision-making results respectively corresponding to the plurality of decision-making objects meet a preset convergence condition, the updated decision-making results respectively corresponding to the plurality of decision-making objects as corresponding target decision-making results.

In one embodiment, the target decision-making module 404 is further configured to:
determine an intermediate decision-making result corresponding to the decision-making object in the iteration according to the edge weight of the first connection edge and the updated decision-making result corresponding to the adjacent decision-making object in the previous round of iteration; and determine the updated decision-making result corresponding to the decision-making object in the iteration according to the dynamic damping coefficient and the intermediate decision-making result.

In one embodiment, the target decision-making module 404 is further configured to:
update the intermediate decision-making result by means of the dynamic damping coefficient to determine the updated decision-making result corresponding to the decision-making object in the iteration according to an updated intermediate decision-making result and the dynamic damping coefficient.

In one embodiment, the association information further includes a first association degree between any two of the decision-making objects, and the first association degree is used to indicate a dependence degree between the two decision-making objects. The association determining module 402 is further configured to:
construct a second relationship graph by means of the plurality of decision-making objects and at least one third-party object, where each node in the second relationship graph corresponds to one decision-making object or one third-party object, and when there is a second connection edge between the decision-making object and the third-party object, an edge weight of the second connection edge is used to indicate a second association degree between the decision-making object and the third-party object; and for two decision-making objects in the second relationship graph that are connected to at least one identical third-party object, determine a first association degree between the two decision-making objects according to a second association degree between each of the two decision-making objects and the identical third-party object.

In one embodiment, the initial decision-making module 401 is further configured to:
acquire a decision-making weight corresponding to at least one decision-making factor, where the decision-making factor is used to perform decision-making processing on the plurality of decision-making objects, and the decision-making weight is used to indicate an influence degree of a corresponding decision-making factor on the decision-making processing; and perform decision-making processing according to the decision-making weight of the decision-making factor and the decision-making factor corresponding to the decision-making objects to obtain the initial decision-making results of the decision-making objects.

In one embodiment, the initial decision-making module 401 is further configured to:
construct a contrast matrix, where an element in an i^{th} row and a j^{th} column in the contrast matrix is used to represent a relative importance degree of an i^{th} decision-making factor compared to a j^{th} decision-making factor, and both i and j are integers greater than or equal to 1; determine a priority matrix according to the contrast matrix, where the priority matrix includes priorities respectively corresponding to the decision-making factors in the contrast matrix; and perform verification on the priority matrix so as to take, if the verification is passed, the priorities included in the priority matrix as decision-making weights of the decision-making factors.

In one embodiment, the initial decision-making module 401 is further configured to:
perform unitization processing on each column in the contrast matrix to obtain a unit contrast matrix; and take an average value of each row in the unit contrast matrix as a priority of each decision-making factor in the priority matrix.

In one embodiment, the initial decision-making module 401 is further configured to:
determine a maximum feature value of the contrast matrix in combination with the contrast matrix and the priority matrix; determine an inspection index according to the maximum feature value and the number of decision-making factors in the contrast matrix; and if the inspection index meets a preset condition, determine that the verification for the priority matrix is passed.

The above apparatus embodiments correspond to the above method embodiments. Specific descriptions may refer to the descriptions in the above method embodiments, and the embodiments of the present application will not be repeated here.

FIG. 7 is a structural block diagram of an electronic device provided by an embodiment of the present application. The electronic device 600 may include a memory 602 and at least one processor 601.

The memory 602 is configured to store computer-executable instructions.

The at least one processor 601 is configured to execute the computer-executable instructions stored in the memory 602, and the electronic device 600 implements the above method for decision-making processing based on the relationship graph.

In addition, the electronic device 600 may further include a receiver 603 and a transmitter 604, where the receiver 603 is configured to receive information from other apparatuses or devices and forward the information to the processor 601, and the transmitter 604 is configured to transmit the information to other apparatuses or devices.

In an exemplary embodiment, a non-transitory computer-readable storage medium is further provided. The computer-readable storage medium has computer-executable instructions stored therein, where the computer-executable instructions, when being executed by a processor, are configured to implement the above method.

In an exemplary embodiment, a computer program product is further provided, configured to implement the above method.

Other implementations of the present application will be apparent to those skilled in the art from consideration of the description and practice the solution disclosed herein. The present application is intended to cover any variations, uses, or adaptations of the present application, following the general principles thereof and including common knowledge or commonly used technical means in this technical field which are not disclosed herein. The description and embodiments are to be considered as exemplary only, and the true scope and spirit of the present application are indicated by the claims.

It should be understood that the present application is not limited to the exact construction that has been described above and illustrated in the accompanying drawings, and that various modifications and changes can be made without departing from the scope thereof. The scope of the present application is only limited by the appended claims.

What is claimed is:

1. A method for decision-making processing based on a relationship graph, comprising:
determining initial decision-making results respectively corresponding to a plurality of decision-making objects;
determining association information among the plurality of decision-making objects, wherein the association information comprises a similarity between any two of the decision-making objects in terms of a decision-making factor;
constructing a first relationship graph according to the association information among the plurality of decision-making objects, wherein each node in the first relationship graph corresponds to one decision-making object, and when there is a first connection edge between the two decision-making objects, an edge weight of the first connection edge is positively correlated with the association information; and
updating, by means of the first relationship graph, the initial decision-making results respectively corresponding to the plurality of decision-making objects, so as to obtain a target decision-making result of each decision-making object.

2. The method according to claim 1, wherein the updating, by means of the first relationship graph, the initial decision-making results respectively corresponding to the plurality of decision-making objects, so as to obtain the target decision-making result of each decision-making object comprises:
for each decision-making object, updating a preset damping coefficient to obtain a dynamic damping coefficient according to an average similarity between the decision-making object and each adjacent decision-making object of the decision-making object in terms of the decision-making factor; and
updating, by means of the dynamic damping coefficient, the initial decision-making results respectively corresponding to the plurality of decision-making objects in the first relationship graph, so as to obtain the target decision-making result of each decision-making object, wherein the dynamic damping coefficient is used to control a decision-making propagation difficulty between the decision-making object and the adjacent decision-making objects.

3. The method according to claim 2, wherein the updating, by means of the dynamic damping coefficient, the initial decision-making results respectively corresponding to the plurality of decision-making objects in the first relationship graph, so as to obtain the target decision-making result of each decision-making object comprises:
in each round of iteration of the updating, for each decision-making object, determining an updated decision-making result of the decision-making object in the iteration according to the dynamic damping coefficient and target information of the decision-making object in the first relationship graph, wherein the target information comprises an edge weight of the first connection edge between the decision-making object and the adjacent decision-making object of the decision-making object in the first relationship graph and an updated decision-making result of the adjacent decision-making object in a previous round of iteration, and the updated decision-making result is initially the initial decision-making result; and
after each round of iteration, taking, on the condition that updated decision-making results respectively corresponding to the plurality of decision-making objects meet a preset convergence condition, the updated decision-making results respectively corresponding to the plurality of decision-making objects as corresponding target decision-making results.

4. The method according to claim 3, wherein the determining the updated decision-making result of the decision-making object in the iteration according to the dynamic damping coefficient and the target information of the decision-making object in the first relationship graph comprises:
determining an intermediate decision-making result corresponding to the decision-making object in the iteration according to the edge weight of the first connection edge and the updated decision-making result corresponding to the adjacent decision-making object in the previous round of iteration; and
determining the updated decision-making result corresponding to the decision-making object in the iteration according to the dynamic damping coefficient and the intermediate decision-making result.

5. The method according to claim 4, wherein the determining the updated decision-making result corresponding to the decision-making object in the iteration according to the dynamic damping coefficient and the intermediate decision-making result comprises:
updating the intermediate decision-making result by means of the dynamic damping coefficient so as to determine the updated decision-making result corresponding to the decision-making object in the iteration according to an updated intermediate decision-making result and the dynamic damping coefficient.

6. The method according to claim 1, wherein the association information further comprises a first association degree between any two of the decision-making objects, and the first association degree is used to indicate a dependence degree between the two decision-making objects; and
the determining the association information among the plurality of decision-making objects comprises:
constructing a second relationship graph by means of the plurality of decision-making objects and at least one third-party object, wherein each node in the second relationship graph corresponds to one decision-making object or one third-party objects, and when there is a second connection edge between the decision-making object and the third-party object, an edge weight of the second connection edge is used to indicate a second association degree between the decision-making object and the third-party object; and
for two decision-making objects in the second relationship graph that are connected to at least one identical third-party object, determining a first association degree between the two decision-making objects according to a second association degree between each of the two decision-making objects and the identical third-party object.

7. The method according to claim 1, wherein the determining the initial decision-making results respectively corresponding to the plurality of decision-making objects comprises:
acquiring a decision-making weight corresponding to at least one decision-making factor, wherein the decision-making factor is used to perform decision-making processing on the plurality of decision-making objects, and the decision-making weight is used to indicate an influence degree of a corresponding decision-making factor on the decision-making processing; and
performing decision-making processing according to the decision-making weight of the decision-making factor and the decision-making factor corresponding to the decision-making objects to obtain the initial decision-making results of the decision-making objects.

8. The method according to claim 7, wherein the acquiring the decision-making weight corresponding to the at least one decision-making factor comprises:
constructing a contrast matrix, wherein an element in an i^{th} row and a j^{th} column in the contrast matrix is used to represent a relative importance degree of an i^{th} decision-making factor compared to a j^{th} decision-making factor, and both i and j are integers greater than or equal to 1;
determining a priority matrix according to the contrast matrix, wherein the priority matrix comprises priorities respectively corresponding to decision-making factors in the contrast matrix; and
performing verification on the priority matrix so as to take, on the condition that the verification is passed, the priorities comprised in the priority matrix as decision-making weights of the decision-making factors.

9. The method according to claim 8, wherein the determining the priority matrix according to the contrast matrix comprises:
performing unitization processing on each column in the contrast matrix to obtain a unit contrast matrix; and
taking an average value of each row in the unit contrast matrix as a priority of each decision-making factor in the priority matrix.

10. The method according to claim 8, wherein the performing verification on the priority matrix comprises:
determining a maximum feature value of the contrast matrix in combination with the contrast matrix and the priority matrix;
determining an inspection index according to the maximum feature value and a number of decision-making factors in the contrast matrix; and
determining that the verification for the priority matrix is passed on the condition that the inspection index meets a preset condition.

11. An apparatus for decision-making processing based on a relationship graph, comprising:
a memory and at least one processor, wherein
the memory is configured to store computer-executable instructions; and
the at least one processor is configured to execute the computer-executable instructions stored in the memory to:
determine initial decision-making results respectively corresponding to a plurality of decision-making objects;
determine association information among the plurality of decision-making objects, wherein the association information comprises a similarity between any two of the decision-making objects in terms of a decision-making factor;
construct a first relationship graph according to the association information among the plurality of decision-making objects, wherein each node in the first relationship graph corresponds to one decision-making object, and when there is a first connection edge between the two decision-making objects, an edge weight of the first connection edge is positively correlated with the association information; and
update, by means of the first relationship graph, the initial decision-making results respectively corresponding to the plurality of decision-making objects, so as to obtain a target decision-making result of each decision-making object.

12. The apparatus according to claim 11, wherein the at least one processor is configured to:
for each decision-making object, update a preset damping coefficient to obtain a dynamic damping coefficient according to an average similarity between the decision-making object and each adjacent decision-making object of the decision-making object in terms of the decision-making factor; and
update, by means of the dynamic damping coefficient, the initial decision-making results respectively corresponding to the plurality of decision-making objects in the first relationship graph, so as to obtain the target decision-making result of each decision-making object, wherein the dynamic damping coefficient is used to control a decision-making propagation difficulty between the decision-making object and the adjacent decision-making objects.

13. The apparatus according to claim 12, wherein the at least one processor is configured to:
in each round of iteration of the updating, for each decision-making object, determine an updated decision-making result of the decision-making object in the iteration according to the dynamic damping coefficient and target information of the decision-making object in the first relationship graph, wherein the target information comprises an edge weight of the first connection edge between the decision-making object and the adjacent decision-making object of the decision-making object in the first relationship graph and an updated decision-making result of the adjacent decision-making object in a previous round of iteration, and the updated decision-making result is initially the initial decision-making result; and
after each round of iteration, take, on the condition that updated decision-making results respectively corresponding to the plurality of decision-making objects meet a preset convergence condition, the updated decision-making results respectively corresponding to the plurality of decision-making objects as corresponding target decision-making results.

14. The apparatus according to claim 13, wherein the at least one processor is configured to:
determine an intermediate decision-making result corresponding to the decision-making object in the iteration according to the edge weight of the first connection edge and the updated decision-making result corresponding to the adjacent decision-making object in the previous round of iteration; and
determine the updated decision-making result corresponding to the decision-making object in the iteration according to the dynamic damping coefficient and the intermediate decision-making result.

15. The apparatus according to claim 14, wherein the at least one processor is configured to:
update the intermediate decision-making result by means of the dynamic damping coefficient so as to determine the updated decision-making result corresponding to the decision-making object in the iteration according to an updated intermediate decision-making result and the dynamic damping coefficient.

16. The apparatus according to claim 11, wherein the association information further comprises a first association degree between any two of the decision-making objects, and the first association degree is used to indicate a dependence degree between the two decision-making objects; and the at least one processor is configured to:
construct a second relationship graph by means of the plurality of decision-making objects and at least one third-party object, wherein each node in the second relationship graph corresponds to one decision-making object or one third-party objects, and when there is a second connection edge between the decision-making object and the third-party object, an edge weight of the second connection edge is used to indicate a second association degree between the decision-making object and the third-party object; and
for two decision-making objects in the second relationship graph that are connected to at least one identical third-party object, determine a first association degree between the two decision-making objects according to a second association degree between each of the two decision-making objects and the identical third-party object.

17. The apparatus according to claim 11, wherein the at least one processor is configured to:
acquire a decision-making weight corresponding to at least one decision-making factor, wherein the decision-making factor is used to perform decision-making processing on the plurality of decision-making objects, and the decision-making weight is used to indicate an influence degree of a corresponding decision-making factor on the decision-making processing; and
perform decision-making processing according to the decision-making weight of the decision-making factor and the decision-making factor corresponding to the decision-making objects to obtain the initial decision-making results of the decision-making objects.

18. The apparatus according to claim 17, wherein the at least one processor is configured to:
construct a contrast matrix, wherein an element in an i^{th} row and a j^{th} column in the contrast matrix is used to represent a relative importance degree of an i^{th} decision-making factor compared to a j^{th} decision-making factor, and both i and j are integers greater than or equal to 1;
determine a priority matrix according to the contrast matrix, wherein the priority matrix comprises priorities respectively corresponding to decision-making factors in the contrast matrix; and
perform verification on the priority matrix so as to take, on the condition that the verification is passed, the priorities comprised in the priority matrix as decision-making weights of the decision-making factors.

19. The apparatus according to claim 18, wherein the at least one processor is configured to:
perform unitization processing on each column in the contrast matrix to obtain a unit contrast matrix; and
take an average value of each row in the unit contrast matrix as a priority of each decision-making factor in the priority matrix.

20. A non-transitory computer-readable storage medium, the computer-readable storage medium has computer-executable instructions stored therein, and the computer-executable instructions, when being executed by a processor, are configured to:
determine initial decision-making results respectively corresponding to a plurality of decision-making objects;
determine association information among the plurality of decision-making objects, wherein the association information comprises a similarity between any two of the decision-making objects in terms of a decision-making factor;
construct a first relationship graph according to the association information among the plurality of decision-making objects, wherein each node in the first relationship graph corresponds to one decision-making object, and when there is a first connection edge between the two decision-making objects, an edge weight of the first connection edge is positively correlated with the association information; and
update, by means of the first relationship graph, the initial decision-making results respectively corresponding to the plurality of decision-making objects, so as to obtain a target decision-making result of each decision-making object.
